(19) United States
(12) Patent Application Publication
(10) Pub. No.: US 2020/0408306 A1
(43) Pub. Date: Dec. 31, 2020

(54) FUGITIVE EMISSIONS PACKING SET

(71) Applicant: Garlock Sealing Technologies, LLC, Palmyra, NY (US)

(72) Inventors: Wayne Evans, Palmyra, NY (US); Dave Roberts, Palmyra, NY (US); Brett Yoder, Palmyra, NY (US); Joseph Young, Palmyra, NY (US)

(21) Appl. No.: 16/905,507

(22) Filed: Jun. 18, 2020

Related U.S. Application Data
(60) Provisional application No. 62/866,375, filed on Jun. 25, 2019.

(51) Int. Cl. F16J 15/18

(52) U.S. Cl. CPC F16J 15/181

(57) ABSTRACT

A fugitive emissions packing set is provided. The packing set a top ring and a bottom ring made from a fluoropolymer that includes a filler that enhances the mechanical and/or dimensional stability of the ring, as compared to unfilled fluoropolymer. The intermediate rings are formed from an essentially pure fluoropolymer. The top, bottom, or intermediate rings may include a metal insert in any combination.

### CROSS-REFERENCE TO RELATED APPLICATIONS

This application claims priority to U.S. Provisional Patent Application No. 62/866,375, filed Jun. 25, 2019 entitled “FUGITIVE EMISSIONS PACKING SET”, the entirety of which is hereby incorporated by reference.

### TECHNICAL FIELD

The present application relates to fugitive emissions packing sets, and more specifically to packing sets including a stack of rings wherein top and bottom rings are made from highly-filled PTFE and intermediate rings located between the top and bottom rings in the stack are made from pure PTFE. Some or all of the rings in the stack may optionally include a resilient metal insert. Some or all of the rings may optionally have angled axial faces, with adjacent rings in the stack having complimentary mating angled axial surfaces.

### BACKGROUND

Packing materials are widely used to reduce or prevent fluid leakage in fluid control systems, such as a rotary shaft or reciprocating stem. Normally, packing is formed of resilient members and is placed under a load in the system. This load can be static or subject to a spring load, known as ‘live’ loading. The spring-loaded packing is particularly useful in preventing leakage by maintaining load on the packing as the axial height changes due to material extrusion, wear, etc. Valve packing typically operates most effectively within a compressive stress range. Live loading maintains packing stress in this target zone through typical operating conditions. Providing a valve packing solution is desired in a variety of different industries and applications. Typically, polymer-based packings are considered for temperatures less than 450° F., and graphite or other equivalent materials are considered for temperatures above 450° F. However, many limitations exist with respect to previously known valve packing solutions and fugitive emission performance. Various governing agencies have implemented more stringent emissions requirements, particularly for valves, driving the need for continuous improvement of this technology.

Within industrial settings there are a variety of pressurized systems. Fugitive emissions are leaks to the atmosphere that occur from these pressurized systems containing a fluid media, which may be a liquid or gas. These emissions are most prevalent from dynamic stem/seal interaction commonly seen on valves. Valves are also one of the most common piping components and typically are the primary source of emissions. The US EPA and other global organizations have pushed for increasingly stringent requirements that limit the pool of commercially available products.

For example, in some cases, the fugitive emission properties of these packing sets are not sufficiently high enough for a given application or industry. Emission performance is often a function of the mechanical quality of the valve, the service conditions, the operator installation, and the quality of the packing set. The quality of the packing design can be improved to accommodate more severe service, but presently known packing sets do not meet the new emissions requirements. This may be because the material used is not thermally stable enough to maintain effective performance or designed in a way to accommodate the material movement inherent with a system changing temperatures.

PTFE is a synthetic fluoropolymer with numerous applications, including compression packing sets for valve service. PTFE is used as a material that is, or at least may be, machined into different geometries, as a filler that is impregnated or coated on different structures, and as a fiber wrap in composite braid structures. PTFE possesses excellent thermal resistance, but its mechanical properties at high temperatures suffers. In addition, the high coefficient of thermal expansion means the functional performance of these products suffer as temperatures vary between −200° F. and 500° F. Mechanical properties are reduced as temperatures approach 500° F.

Polymers typically have higher coefficients of thermal expansion, as well as decreasing mechanical properties as temperatures rise. As these mechanical properties decrease, functional performance typically suffers. Many packing sets require a target compressive stress to effectively perform. When material extrudes from the sealing gland, the compressive stress decreases. One method to accommodate this is through live loading.

Live loading can be accomplished in different manners. One common approach is uses spring washers (also known as Belleville washers, coned disc springs, conical spring washers, disc springs, or cupped spring washers) on the bolts providing compressive force on the packing set. Another approach is a large spring located around the stem and applying spring load directly on the packing set.

Live loading can occur through polymer selection in addition to metallic elements. Various polymers possess different compressibility and recovery values that can be utilized. Rubber typically has much better compressibility and recovery properties than PTFE. Integrating rubber elements into machined PTFE sets is one manner to introduce an axial and radial spring force without a metallic element.

The sealing member maintaining a minimum contact with the dynamic surface is important to successful performance. This can occur through live loading techniques discussed previously. Alternatively, this can be accomplished by article geometries designed to flex in specific manners. Commercially available examples are the Quad Ring O-ring, lip seals, HermetiX™, and cup and cone designs for packing materials. Typically, there is some type of pressure activated face, as well as a geometry designed to deform against the dynamic surface when load is applied.

### SUMMARY

Described herein are various embodiments of a fugitive emissions packing set generally including a stack of rings, wherein the material of the top and bottom rings in the stack is different from the material of the intermediate rings located between the top and bottom rings.

In some embodiments, top and bottom rings in the packing set are made from a fluoropolymer that includes a filler. Polytetrafluoroethylene (“PTFE”) is one such fluoropolymer that may include one or more fillers. The filled PTFE includes filler material that provides a top ring and a bottom ring with high mechanical stability, as compared to unfilled PTFE. In some embodiments, the intermediate rings are made from essentially pure PTFE. The pure PTFE material provides compressible rings that improve sealing properties. The top and bottom rings, the intermediate rings, or any combination thereof can include a metal insert embedded within the ring. In other words, the ring may comprise a fluoropolymer that encompasses a metal disc, which has an inner diameter larger than the top, bottom, and intermediate rings and an outer diameter smaller than the top, bottom, and intermediate rings such that the metal disc is fully encapsulated in the polymer.

### BRIEF DESCRIPTION OF THE DRAWINGS

FIG. 1A illustrates a cross-section view of a fugitive emissions packing set according to various embodiments described herein;

FIG. 1B illustrates a cross-section view of a fugitive emissions packing set according to various embodiments described herein; and

FIG. 2 illustrates a perspective see-through view of a ring of a packing set according to various embodiments described herein.

### DETAILED DESCRIPTION

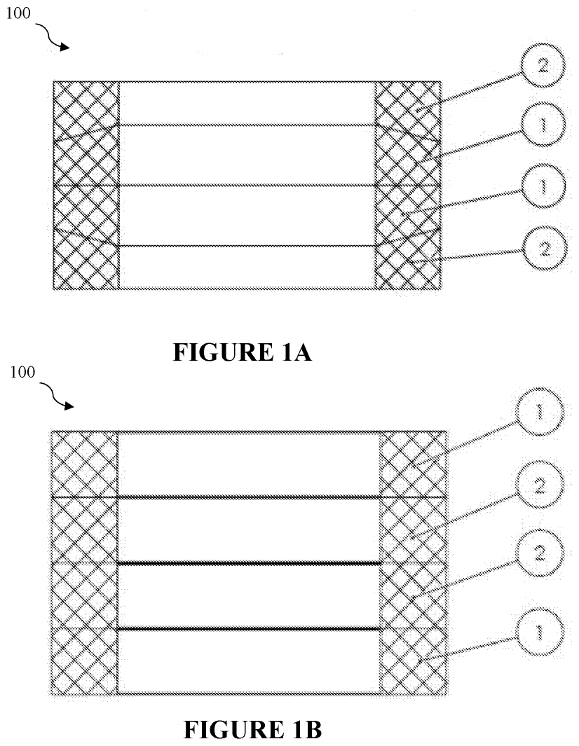

With reference to FIGS. 1A and 1B, a fugitive emission packing set 100 according to various embodiments described herein is shown. The packing set 100 includes a plurality of rings 1, 2 staked axially and concentrically aligned. In other words, each of the plurality of rings has equal inner and outer diameters. Each ring 1, 2 having the same inner and outer diameter provides that the internal and external surfaces of the set 100 are planar, or have the same tangent at any given location on the radially inner and outer sidewalls of the set 100. The specific inner and outer diameter dimensions of the rings 1, 2 are not limited and can be selected based on the specific application for the packing set 100. For example, the inner diameter of the rings 1, 2 can be selected to be approximately equal to a stem that will be passed through the internal passageway of the packing set 100. The outer diameter may be equal to the cylindrical valve body holding the packing set.

As shown in FIGS. 1A and 1B, the packing set 100 generally includes intermediate rings 1 positioned between top and bottom rings 2 located at the axial top and bottom of the packing set 100. The top and bottom rings 2 have an internally facing surface facing the intermediate ring (or rings) 1 and an externally facing surface opposite the internally facing surface. Similarly, the intermediate rings 1 have opposed axially facing surfaces. The axially facing surfaces are configured to engagingly mate with adjacent surfaces, which adjacent surfaces may include the internally facing surface of rings 2 or axially facing surfaces of corresponding other intermediate rings 1. While the ID and OD dimensions of the rings 1, 2 are identical, the rings 1, 2 are dissimilar in the material composition. Intermediate rings 1 are made from essentially pure polytetrafluoroethylene (“PTFE”), while top and bottom rings are made from filled PTFE (i.e., PTFE having filler incorporated therein). This difference in material provides top and bottom rings 2 that have high mechanically stability and dimensional stability, and intermediate rings 1 that are soft and compressible. As can now be appreciated, essentially pure PTFE means, in this application, the PTFE may have fillers but does not have fillers that enhance the mechanical and/or dimensional stability of pure PTFE more than a deminimus amount. In other words, essentially pure PTFE may comprise fillers that increase the sealing ability, the lubriciousness, or the like. The essentially pure PFTE intermediate rings generally provide sealing against the valve stem (or shaft of a reciprocating device) and the top and bottom rings generally provide for ant-extrusion. This configuration provides for a packing set 100 with improved sealing properties and overall mechanical and dimensional stability. For example, the filed PTFE top and bottom rings 2 will not extrude, and the top and bottom rings 2 squeeze the intermediate rings 1 against the stem that passes through the central passageway of the packing set 100.

With respect to rings 2 made from filled PTFE, the filler of the PTFE is generally not limited although the filler is generally selected to provide mechanical stability and/or dimensional stability to the PTFE, especially at higher temperatures. In some embodiments, the filler is selected from barium sulfate, graphene, silica and aluminosilicate microspheres, stainless steel, silicon carbide, brass, glass fibers, or combinations thereof. In some embodiments, an aim of the filler is to beneficially impact the mechanical stability of the ring. Other fillers known to improve the material properties of the PTFE can also be used. Selecting the correct filler based on the specific application of the packing set 100 can help to reduce flow issues typically associated with polymer sealing solutions. Often these fillers are selected based off factors such as chemical compatibility, purity levels, and/or other end user process related requirements.

Any suitable amount of filler can be added to the PTFE. In some embodiments, the amount of filler included in the PTFE is between 35 and 70 vol % of the filler ring. In a specific example, the amount of filler included in the PTFE is 40 vol %. In another specific example, the amount of filler included in the PFTE is 67 vol %. In addition to increasing mechanical and dimensional stability (e.g. the ring is less likely to experience fatigue and/or creep), increased filler amount can also make machining of the rings easier. For example, frictional heat from machining has less impact due to increased mechanical stability and decreased PTFE content of ring material.

With respect to intermediate rings 1, the material of the rings 1 is essentially pure PTFE. However, in some embodiments, the PTFE of the intermediate rings may include amounts of polymeric fillers, such as ceramers and polyesters (such as EKONOL®) that improve the sealability and performance under certain conditions, such as vacuums. In other words, the intermediate rings 1 should be essentially pure PTFE (e.g., no filler) or at least essentially no fillers that enhance the mechanical or dimensional stability of the intermediate rings 1. This facilitates the compressibility of intermediate rings 1. When the intermediate rings 1 are compressed, they push against the stem passing through the central passageway of the set 100 and form an improved seal.

With respect to either intermediate rings 1 or top and bottom rings 2, the base material used to make the rings 1, 2 can be biaxially fibrillated PTFE. For example, the rings can be formed from sheets of biaxially fibrillated PTFE. This base material can be formed via fibrillating processes that create a homogenous mixture of the PTFE in biaxial directions.

The PTFE material of rings 1, 2, can, in some embodiments, be calendared. Any suitable calendaring process can be used, and will generally result densifying the PTFE. In some embodiments, calendaring is only used for top and bottom rings 2 wherein increased mechanical stability that comes from densifying is desired.

With specific reference to FIG. 1A, in some embodiments, the rings 1, 2 include at least one axial face that is angled. For example, and as shown in FIG. 1A, top and bottom rings 2 include inwardly facing axial faces that are angled to slope upwardly from the internal diameter to the outer diameter. In other words, the thickness of the ring 2 increases from the internal diameter to the outer diameter. The outwardly facing axial face of the top and bottom ring remains planar. Correspondingly, the intermediate rings 1 have outwardly facing axial faces that are angled to slope downwardly from the internal diameter to the outer diameter. In other words, the thickness of the rings 1 decreases from the internal diameter to the outer diameter. The inwardly facing axial face of the intermediate rings remains planar. As shown in FIG. 1A, the angle surfaces of the rings 1, 2 are designed to mate with corresponding faces of adjacent rings to form flush surfaces between angled faces. Any angle can be used for the angled faces provided adjacent rings have complimentary angles so that adjacent rings remain flush against one another when combined in a set 100.

While not shown in FIG. 1A, the intermediate rings 1 can also have angled axial faces on both axial sides of the rings, rather than 1 planar axial surface and one angled surface. In such embodiments, adjacent intermediate rings must have complimentary angled faces to ensure flush mating against adjacent rings.

When rings with angled axial surfaces are used in the set 100, such as is shown in FIG. 1A, the angled surfaces that are ‘flexed’ during installation may retain radial spring load more effectively.

With specific reference to FIG. 1B, all rings used in the set 100 have planar axial faces. As such, any ring in the set 100 shown in FIG. 1B can be adjacent to any other ring in the set 100 shown in FIG. 1B and provide a flush interface between adjacent rings.

While not illustrated herein, a set 100 may include both rings that have only planar axial surfaces (such as shown in FIG. 1B) and rings having angled axial surfaces (as shown in FIG. 1A). For example, the set 100 shown in FIG. 1A could be modified to be a 5-ring set by including a third intermediate ring 1 located between the intermediate rings 1 already shown in FIG. 1A. The third intermediate ring 1 could have only planar axial surfaces so that the third intermediate ring 1 mate flush with the planar axial surface of the intermediate rings 1 shown in FIG. 1A.

Ultimately, any combination of rings having either both planar axial surfaces, one angled axial surface and one planar axial surface, or both angled axial surfaces, provided that adjacent rings have complimentary surfaces to provide a flush fit between adjacent surfaces can be used part of a set 100.

When angled axial faces are used, any manner of creating the angled axial faces can be used. In some embodiments, cold molding is used to manufactured rings with angled axial faces. In some embodiments, the machining of the rings is used to form angled axial faces.

The packing set 100 shown in FIGS. 1A and 1B includes four rings total. However, it should be appreciated that as few as three rings can be used (top and bottom rings 2 and one intermediate ring 1). It should also be appreciated that more than four rings can be used, with exemplary stacks including five, six, or more rings (top and bottom rings 2 and 3 or more intermediate rings). Regardless of the number of rings used, the top-most and bottom-most rings 2 are made from filled PTFE as described above and any intermediate rings 1 between the top and bottom rings 2 are made from essentially pure PTFE. Essentially pure PTFE means PTFE without fillers that increase the mechanical and dimensional stability of the ring.

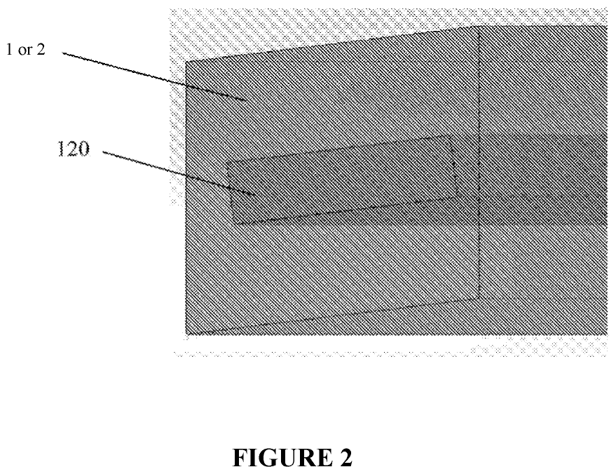

With reference to FIG. 2, one or more of the rings included in the packing set 100 can be formed with a metal insert 120 embedded within the ring. A ring insert 120 can be provided to add further mechanical strength and, in some embodiments, to provide a spring force from within the rings that helps to promote better sealing. Any suitable metal insert 120 can be provided within the PTFE provided the insert 120 provides at least some mechanical improvement and/or spring force. As shown in FIG. 2, the metal insert 120 is a Belleville washer, but other inserts such as coned disc springs, conical spring washers, disc springs, or cupped spring washers can also be used. In some embodiments, the metal insert is provided only in the top and bottom rings 2 of the set 100.

The specific orientation and placement of the metal insert 120 within the ring is generally not limited. In some embodiments, such as is shown in FIG. 2, the metal insert 120 is located in a generally central location within the ring and is slightly angled so that as the set 100 is compressed downward, the metal insert 120 exerts force in a direction that improves the sealing against a stem passing through a central passageway of the set 100.

In order to manufacture the rings having metal inserts embedded therein as shown in FIG. 2, molding techniques are generally used to embed the metal insert within the ring. For example, a first layer of PTFE can be provided in a mold, followed by placing a metal insert 120 on top of the first layer and then covering the metal insert with a further layer of PTFE. The mold may then be closed and compressed/heated to fuse together the PTFE layers and embed the metal insert. This assembly method is simple for end users.

Although the technology has been described in language that is specific to certain structures and materials, it is to be understood that the invention defined in the appended claims is not necessarily limited to the specific structures and materials described. Rather, the specific aspects are described as forms of implementing the claimed invention. Because many embodiments of the invention can be practiced without departing from the spirit and scope of the invention, the invention resides in the claims hereinafter appended. Unless otherwise indicated, all numbers or expressions, such as those expressing dimensions, physical characteristics, etc. used in the specification (other than the claims) are understood as modified in all instances by the term “approximately.” At the very least, and not as an attempt to limit the application of the doctrine of equivalents to the claims, each numerical parameter recited in the specification or claims which is modified by the term “approximately” should at least be construed in light of the number of recited significant digits and by applying ordinary rounding techniques. Moreover, all ranges disclosed herein are to be understood to encompass and provide support for claims that recite any and all subranges or any and all individual values subsumed therein. For example, a stated range of 1 to 10 should be considered to include and provide support for claims that recite any and all subranges or individual values that are between and/or inclusive of the minimum value of 1 and the maximum value of 10; that is, all subranges beginning with a minimum value of 1 or more and ending with a maximum value of 10 or less (e.g., 5.5 to 10, 2.34 to 3.56, and so forth) or any values from 1 to 10 (e.g., 3, 5.8, 9.9994, and so forth).

What is claimed is:

1. A packing set comprising,
a pair of end rings on opposed ends of the packing set, the pair of end rings comprising polytetrafluoroethylene (PTFE) with a filler material, wherein the filler material enhances a dimensional stability of the pair of end rings, the pair of end rings having an outer diameter and an inner diameter defining an aperture; and
at least one intermediate ring between the pair of end rings, wherein the at least one intermediate ring comprises PTFE, the at least one intermediate ring having an outer diameter equal to the outer diameter of the pair of end rings and an inner diameter defining an aperture equal to the inner diameter of the pair of end rings, such that the radially inner and radially outer surfaces are planar.

2. The packing set of claim 1 wherein the at least one intermediate ring comprises pure PTFE.

3. The packing set of claim 1 wherein the at least one intermediate ring consists essentially of pure PTFE.

4. The packing set of claim 1 wherein the at least one intermediate ring comprises a polymeric filler material.

5. The packing set of claim 1 wherein the pair of end rings and the at least one intermediate ring comprise planar axial surfaces.

6. The packing set of claim 1 wherein the pair of end rings comprise a planar axial surface and an angled axial surface and wherein the at least one intermediate ring has at least one axial surfaces conforming to the angled axial surface.

7. The packing set of claim 1 wherein the filler material is selected from a group of filler materials that enhance mechanical or dimensional stability consisting of: barium sulfate, graphene, silica and aluminosilicate microspheres, stainless steel, silicon carbide, brass, glass fibers, or combinations thereof.

8. The packing set of claim 1 wherein the at least one intermediate ring comprises a plurality of intermediate rings.

9. The packing set of claim 1 wherein at least one of the pair of end rings or the at least one intermediate ring comprises a metal insert.

10. The packing set of claim 9 wherein each of the pair of end rings and the at least one intermediate ring comprises a metal insert.

11. The packing set of claim 9 wherein the metal insert is angled such that when the metal insert is compressed, the metal insert provides a sealing force.

12. The packing set of claim 9 wherein each of the pair of end rings comprises a metal insert.

13. The packing set of claim 9 wherein only the pair of end rings comprises a metal insert.

14. A packing set comprising,
a pair of end rings on opposed ends of the packing set, the pair of end rings comprising a fluoropolymer with a filler material, wherein the filler material enhances a dimensional stability of the pair of end rings, the pair of end rings having an outer diameter and an inner diameter defining an aperture; and
at least one intermediate ring between the pair of end rings, wherein the at least one intermediate ring comprises an essentially pure fluoropolymer, the at least one intermediate ring having an outer diameter equal to the outer diameter of the pair of end rings and an inner diameter defining an aperture equal to the inner diameter of the pair of end rings, such that the radially inner and radially outer surfaces are planar.

15. The packing set of claim 14 wherein the at least one intermediate ring comprises a polymeric filler material.

16. The packing set of claim 14 wherein the filler material is selected from a group of filler materials that enhance mechanical or dimensional stability consisting of: barium sulfate, graphene, silica and aluminosilicate microspheres, stainless steel, silicon carbide, brass, glass fibers, or combinations thereof.

17. The packing set of claim 14 wherein the fluoropolymer comprises polytetrafluoroethylene.

18. A packing set comprising,
a pair of end rings on opposed ends of the packing set, the pair of end rings comprising polytetrafluoroethylene (PTFE) with a filler material, wherein the filler material enhances a dimensional stability of the pair of end rings, the pair of end rings having an outer diameter and an inner diameter defining an aperture, each of the pair of end rings having an externally facing surface and an internally facing surface where at least the internally facing surface is angled relative to the externally facing surface; and
at least one intermediate ring between the pair of end rings, wherein the at least one intermediate ring comprises PTFE, the at least one intermediate ring having an outer diameter equal to the outer diameter of the pair of end rings and an inner diameter defining an aperture equal to the inner diameter of the pair of end rings, such that the radially inner and radially outer surfaces are planar, the at least one intermediate ring comprising axially facing surfaces configured to engagingly mate with adjacent surfaces.

19. The packing set of claim 18 wherein the at least one intermediate ring is pure PTFE.

20. The packing set of claim 19 wherein the filler material is selected from a group of filler materials that enhance mechanical or dimensional stability consisting of: barium sulfate, graphene, graphite, silica and aluminosilicate microspheres, stainless steel, silicon carbide, brass, fiberglass, glass fibers, or combinations thereof.
